(19) United States
(12) Patent Application Publication
(10) Pub. No.: US 2021/0352858 A1
(43) Pub. Date: Nov. 18, 2021

(54) LEAF BAGGER

(71) Applicant: Morgan Tim Welch, Highland, UT (US)

(72) Inventor: Morgan Tim Welch, Highland, UT (US)

(21) Appl. No.: 17/323,864

(22) Filed: May 18, 2021

Related U.S. Application Data
(60) Provisional application No. 63/026,622, filed on May 18, 2020.

(51) Int. Cl. A01G 20/47; B02C 23/24

(52) U.S. Cl. CPC A01G 20/47; B02C 23/24

(57) ABSTRACT

An apparatus for bagging leaves is disclosed as including a gathering bin comprising an inlet having a larger mouth that tapers to an outlet having a smaller mouth. The apparatus further includes a tunnel that has a first end coupled to the outlet, and a second end that includes an attachment mechanism configured to releasably secure a garbage bag. In certain embodiments, the gathering bin has a floor configured to contact the ground, and a canopy above the floor. In certain embodiments, the canopy is supported by flexible and removable rods, thereby allowing the apparatus to be collapsed and stored when not in use. A corresponding method is also disclosed.

### BACKGROUND

### Field of the Invention

This invention relates to apparatus and methods for bagging leaves and other vegetation.

### Background of the Invention

Fall leaves are beautiful when they turn trees and other vegetation shades of gold, orange and red. Once those same leaves fall to the ground and turn brown, however, they can create an unsightly and in some cases hazardous mess. Not only do mounds of dead leaves clutter a lawn and other landscaping, they can also cause bald spots in grass, leave stains on concrete, and become a haven for mold and mildew. In some cases, they may create a safety hazard by covering and camouflaging objects that may pose a danger to people or animals passing thereby. Thus, fallen leaves are ideally collected in a timely manner to prevent or reduce the above-described issues from occurring. However, collecting and removing such leaves can be a daunting and cumbersome task, particularly with large yards or yards that contain a large number of trees and/or bushes.

In view of the foregoing, apparatus and methods are needed to quickly and efficiently collect leaves that have fallen to the ground. Ideally, such apparatus and methods can take advantage of other tools, such as leaf blowers, that are used for other landscaping tasks.

### SUMMARY

The invention has been developed in response to the present state of the art and, in particular, in response to the problems and needs in the art that have not yet been fully solved by currently available apparatus and methods. Accordingly, apparatus and methods in accordance with the invention have been developed to quickly and efficiently collect leaves and other vegetation. The features and advantages of the invention will become more fully apparent from the following description and appended claims, or may be learned by practice of the invention as set forth hereinafter.

Consistent with the foregoing, an apparatus for bagging leaves is disclosed in one embodiment of the invention as including a gathering bin comprising an inlet having a larger mouth that tapers to an outlet having a smaller mouth. The apparatus further includes a tunnel that has a first end coupled to the outlet, and a second end that includes an attachment mechanism configured to releasably secure a garbage bag. In certain embodiments, the gathering bin has a floor configured to contact the ground, and a canopy above the floor. In certain embodiments, the canopy is supported by flexible and removable rods, thereby allowing the apparatus to be collapsed and stored when not in use.

In another embodiment of the invention, a method for bagging leaves includes gathering leaves using a gathering bin comprising an inlet having a larger mouth that tapers to an outlet having a smaller mouth. The leaves are conveyed from the gathering bin through a tunnel having a first end that is coupled to the outlet, and a second end that includes an attachment mechanism configured to releasably secure a garbage bag.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a front view showing one embodiment of a leaf bagger in accordance with the invention;

FIG. 2 is a top view of one embodiment of the leaf bagger of FIG. 1 coupled to a garbage bag;

FIG. 3 is a perspective view showing one embodiment of a tunnel providing a transition between the leaf bagger and a garbage bag; and

FIG. 4 is a front view showing one embodiment of a leaf bagger that includes extensions to increase a width of the leaf bagger.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

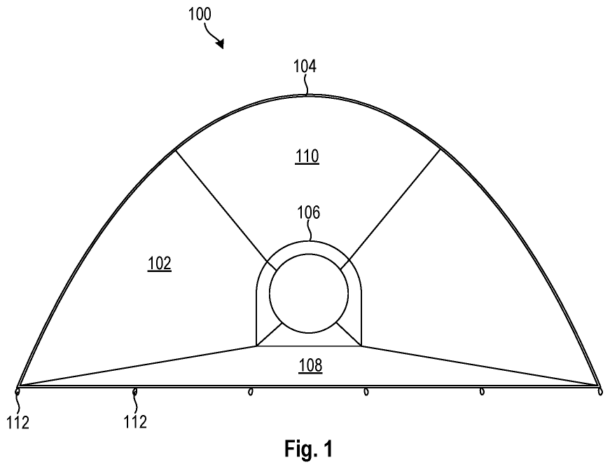

Referring now to FIG. 1, a front view of one embodiment of a leaf bagger 100 in accordance with the invention is illustrated. As shown, the leaf bagger 100 includes a gathering bin 102 to gather leaves or other vegetation that are blown or otherwise pushed into the gathering bin 102. The front of the gathering bin 102 forms an inlet 104 with a large mouth that tapers to an outlet 106 with a relatively smaller mouth. In certain embodiments, a common landscaping tool such as a leaf blower is used to blow leaves into the gathering bin 102.

As shown, the gathering bin 102 includes a floor 108 and a canopy 110 that resides above the floor 108. The floor 104 may lie against the ground and the canopy 110 may extend upwards away from the ground. In certain embodiments, the floor 108 is attached to the ground by stakes or other anchors at one or more attachment points 112. The anchors may help to ensure that the leaf bagger 100 will resist both the weight of leaves and wind to maintain its structural integrity. In certain embodiments, flexible and removable rods may be used to support the canopy 110 above the floor 108, as well as keep the floor 108 taut, as is commonly used with dome and other tents. Similarly, the gathering bin 102 may, in certain embodiments, be made of a flexible and water-safe fabric such as nylon or polyester, similar to that used with dome or other tents.

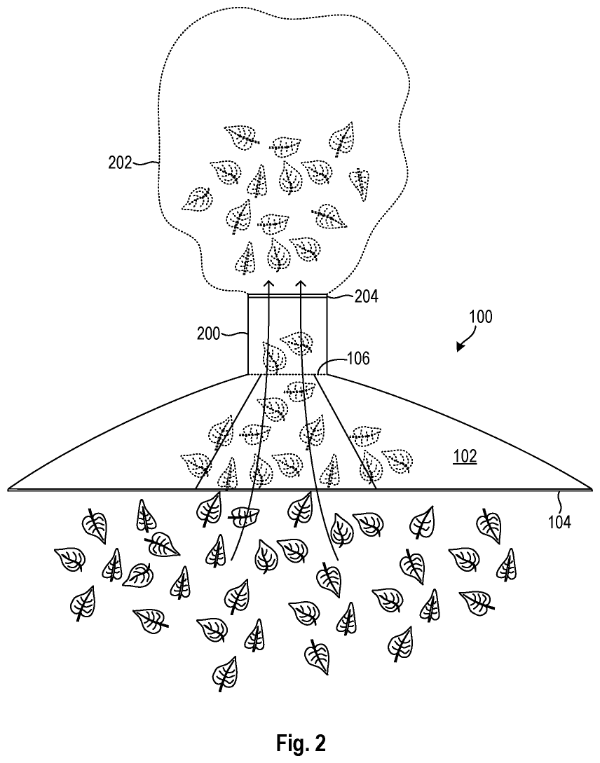

Referring to FIG. 2, a top view of the leaf bagger 100 of FIG. 1 is illustrated. As shown, the gathering bin 102 of the leaf bagger 100 includes a wide-mouth inlet 104 intended to receive and funnel vegetation such as leaves through the outlet 106. In certain embodiments, the outlet 106 may interface with a tunnel 200 that leads to a garbage bag 202. The tunnel 200 may include an attachment mechanism 204 that releasably secures the garbage bag 202. This attachment mechanism 204 may include clips, brackets, rings, elastic bands, or other components to attach the garbage bag 202 to the end of the tunnel 200.

As shown, leaves that are blown or otherwise collected by the gathering bin 102 are funneled into the tunnel 200 and conveyed into the garbage bag 202. In certain embodiments, this is accomplished by blowing leaves through the gathering bin 102 and tunnel 200 using a leaf blower. The wide-mouth inlet 104 of the gathering bin 102 may provide a large target to collect the leaves. Once the garbage bag 202 is full, the garbage bag 202 may be removed from the attachment mechanism 204 and a new empty garbage bag 202 may be attached thereto. The new garbage bag 202 may then be filled in the same manner. The leaf bagger 100 provides an easy way to fill garbage bags 202 with leaves or other vegetation compared to the typical technique of raking leaves and manually scooping them into a garbage bag 202.

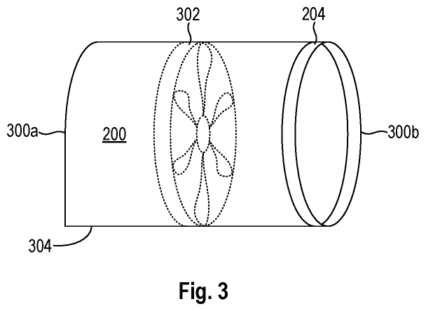

Referring to FIG. 3, one embodiment of a tunnel 200 is illustrated. As shown, the tunnel 200 includes a first end 300a that interfaces with the outlet 106 of the gathering bin 102, and a second end 300b that interfaces with a garbage bag 202. As shown, the second end 300b includes an attachment mechanism 204 that may include clips, rings, brackets, and/or elastic bands to hold the garbage bag 202 in place. In certain embodiments, the first end 300a has a flat bottom 304 so that leaves and other vegetation can more easily pass from the floor 108 of the gathering bin 102 into the tunnel 200. The tunnel 200 may be somewhat self-supporting and wide to allow leaves to pass therethrough without creating blockages.

Optionally, in certain embodiments in accordance with the invention, a shredder 302 may be incorporated into the tunnel 200. The shredder 302 may be positioned at or near the first end 300a or second end 300b or somewhere in between. The shredder 302 may be used to shred leaves or vegetation that pass through the tunnel 200 into the garbage bag 202. The shredder 302 may, in certain embodiments, be electrically driven by a motor that is powered by a battery, electrical outlet, or the like. Among other benefits, the shredder 302 may significantly reduce the volume of leaves or vegetation that are pushed through the tunnel 200, thereby reducing the number of garbage bags 202 used and the frequency that garbage bags 202 need to be replaced.

In certain embodiments, the shredder 302 may also be configured to produce a vacuum that pulls leaves or vegetation through the gathering bin 102 and into the tunnel 200 towards the shredder 302. The shredder 302 may then expel the resulting shredded material into the garbage bag 202. Among other benefits, the vacuum may prevent leaves or vegetation from compacting and/or clogging the tunnel 200 as the leaves or vegetation are raked or other otherwise placed into the gathering bin 102. Because the vacuum may draw leaves or vegetation toward the shredder 302, this may reduce blockages or clogs caused by pushing leaves or vegetation into the tunnel 200. The shredded material that is expelled from the shredder 302 may also be less prone to clog or compact within the tunnel 200 before it reaches the garbage bag 202.

In certain embodiments, the tunnel 200 is configured to release pressure that may build up inside the tunnel 200. For example, when leaves or vegetation are blow into the gathering bin 102, pressure may build up inside the tunnel 200 that may prevent air and leaves or vegetation from reaching the garbage bag 202. In certain embodiments, apertures are incorporated into the tunnel 200 to allow this pressure to be released. In certain embodiments, this may be as simple as constructing the tunnel 200 of a breathable or mesh-like material that allows pressure to be released through the walls of the tunnel 200. In other embodiments, pressure may be released at the interface between the tunnel 200 and the garbage bag 202 such as by providing a loose fitting connection between the tunnel 200 and garbage bag 202. Other techniques for releasing pressure from the tunnel 200 are possible and within the scope of the invention.

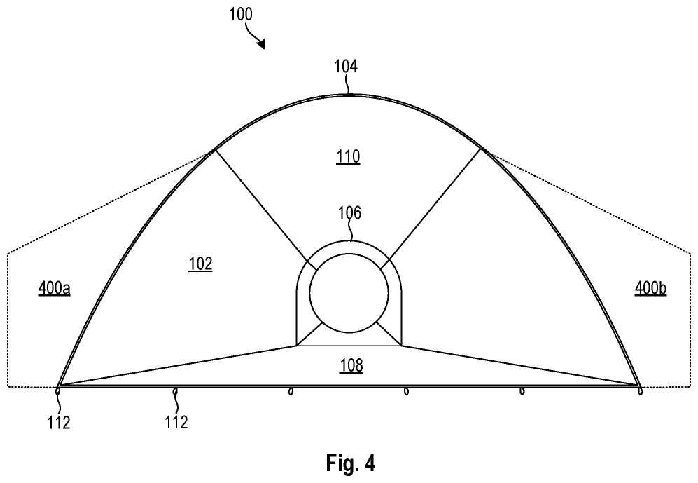

Referring to FIG. 4, in certain embodiments in accordance with the invention, the width of the leaf bagger 100 may be increased to improve its ability to gather leaves or vegetation that are blown into the gathering bin 102. In certain embodiments, extensions 400a, 400b may be provided on sides of the gathering bin 102 to, in effect, enable the gathering bin 102 to cast a wider net. This may allow more leaves or vegetation to be funneled into the gathering bin 102 with a leaf blower or other tool. This may also prevent or reduce an amount of leaves or vegetation that are blown past or behind the leaf bagger 100. For example, if the leaf bagger 100 is placed in the corner of a fenced yard to collect leaves that are blown into it from the rest of the yard, the extensions 400a, 400b may be extended to the fence on each side of the leaf bagger 100 to prevent leaves or vegetation from being blown past or behind the leaf bagger 100. In certain embodiments, the extensions 400a, 400b are supported with stakes or poles, or are tied to objects such as fences or trees with cords.

In the above disclosure, reference has been made to the accompanying drawings which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

While various embodiments of the present disclosure have been described above, it should be understood that they have been presented by way of example only and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teachings. Further, it should be noted that any or all of the aforementioned alternate implementations may be used in any combination desired to form additional hybrid implementations of the disclosure.

1. An apparatus for bagging leaves, the apparatus comprising:
a gathering bin comprising an inlet having a larger mouth that tapers to an outlet having a smaller mouth; and
a tunnel having a first end that is coupled to the outlet, and a second end that comprises an attachment mechanism configured to releasably secure a garbage bag.

2. The apparatus of claim 1, wherein the gathering bin comprises at least one anchor point to attach the gathering bin to the ground.

3. The apparatus of claim 1, wherein the gathering bin comprises a floor configured to contact the ground, and a canopy above the floor.

4. The apparatus of claim 3, wherein the canopy is supported by flexible and removable rods.

5. The apparatus of claim 1, wherein the gathering bin further comprises extensions configured to increase a size of the larger mouth.

6. The apparatus of claim 5, wherein the extensions are adjustable to selectively adjust the size of the larger mouth.

7. The apparatus of claim 1, further comprising a shredder incorporated into the tunnel.

8. The apparatus of claim 7, wherein the shredder further produces a vacuum configured to pull vegetation through the shredder.

9. The apparatus of claim 1, wherein the tunnel comprises apertures to enable pressure to be released from inside the tunnel.

10. The apparatus of claim 9, wherein the apertures are positioned at an interface between the tunnel and a garbage bag.

11. A method for bagging leaves, the method comprising:
gathering vegetation using a gathering bin comprising an inlet having a larger mouth that tapers to an outlet having a smaller mouth; and
conveying the vegetation through a tunnel having a first end that is coupled to the outlet, and a second end that comprises an attachment mechanism configured to releasably secure a garbage bag.

12. The method of claim 11, further comprising attaching the gathering bin to the ground using at least one anchor point on the gathering bin.

13. The method of claim 11, wherein the gathering bin comprises a floor configured to contact the ground, and a canopy above the floor.

14. The method of claim 13, further comprising supporting the canopy with flexible and removable rods.

15. The method of claim 11, further comprising increasing a size of the larger mouth using extensions attached to the gathering bin.

16. The method of claim 15, further comprising selectively adjusting a size of the larger mouth using the extensions.

17. The method of claim 11, further comprising passing the vegetation through a shredder incorporated into the tunnel.

18. The method of claim 17, further comprising producing a vacuum to pull the vegetation through the shredder.

19. The method of claim 11, further comprising releasing pressure from inside the tunnel using apertures incorporated therein.

20. The method of claim 19, further comprising positioning the apertures at an interface between the tunnel and a garbage bag.
